(19) United States
(12) Patent Application Publication
(10) Pub. No.: US 2005/0076358 A1
(43) Pub. Date: Apr. 7, 2005

(54) Apparatus, system, and method for measuring data broadcast viewing information

(75) Inventor: Takayoshi Yamada, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/929,407

(22) Filed: Aug. 31, 2004

(30) Foreign Application Priority Data
Sep. 1, 2003 (JP) 2003-308825

(51) Int. Cl. H04N 7/16; H04H 9/00

(52) U.S. Cl. 725/14; 725/9; 725/13

(57) ABSTRACT

This invention enables measuring viewing information on a viewer who views each content even if a plurality of contents are included in one channel. A digital broadcast receiver includes a viewing information detection unit which detects identification information on a file having a content viewed by the viewer, identification information on a stream to which the file belongs, identification information on a channel to which the stream belongs, a program name, a program category, personal information, a command, and a view date; and a transmission unit which transmits the identification information on the file, on the stream, on the channel, the program name, the program category, the personal information, the command, and the date thus detected. A viewing information aggregating apparatus receives the data transmitted from the transmission unit through the Internet, and calculates a rating for each content file based on the received data.

### BACKGROUND OF THE INVENTION

1. Field of the Invention

The present invention relates to a data broadcast viewing information measuring apparatus, a data broadcast viewing information measuring system, and a data broadcast viewing information measuring method for measuring ratings for a data broadcast.

2. Description of the Related Art

Conventionally, the following method has been normally adopted to measure television ratings. 1. A measuring apparatus such as a people meter is connected to a television receiver in each house and a television viewing status is recorded. 2. Recorded viewing data is transferred to a computer center in a rating survey company using a data line (an automatic dial) early in the morning every day. 3. The transferred viewing data is aggregated and ratings are calculated. Ratings per minute can be thereby aggregated, so that a rating of a program in each time zone, a rating of the program at commercial time, and the like can be grasped.

Meanwhile, digital broadcasting has spread in recent years. Specifically, BS digital broadcasting became a reality in 2000, CS digital broadcasting became a reality in 2002, and terrestrial digital broadcasting became a reality in 2003 in Japan. In digital broadcasting, a program can be broadcast while including a data content in the program, thereby motivating each broadcasting station to provide a service taking advantage of the digital broadcasting. To gain high ratings for its own broadcasting station, the broadcasting station is considered to create a data content of a game and a data content of a TV commercial in expectation of gaining a commercial income. For this reason, each broadcasting station is concerned about not only a rating of a channel but also how many viewers view data contents which the broadcasting station provides.

Data broadcasting coding and transmitting techniques for the digital broadcasting are specified in ARIB STD-B24 in Japan. “ARIB” is an abbreviation for “Association of Radio Industries and Businesses”. In Japan, every content of a data broadcast on the air is described in BML (Broadcast Markup Language). The BML is an applied language of XML and conforms to standards of CSS (Cascading Style Sheets), DOM (Document Object Model), or ECMA Script. In the US, every content is described in XDML, OCAP HTML, or the like. In European countries, every content is described in DVB-HTML or the like.

A digital broadcast includes video, voice, data, and the like, which are transmitted by means of an MPEG-TS (Moving Picture Experts Group-Transport Stream). One MPEG-TS includes a video stream, a plurality of voice streams, a plurality of data streams, a subtitle stream, a character super stream, and the like. Each stream is identified by a component tag. In each data stream, a plurality of BML files are combined into a set and subjected to carousel transmission.

Japanese Patent Application Laid-Open No. 2002-217850(JP-A) discloses the following techniques. In order to grasp a correspondence between a broadcast content and a viewer class who view the content, identification information on the content and individual data on each viewer are collected while making them correspond to each other. Identification information which makes the content identifiable without broadcast time information so that the correspondence between the viewed content and the viewer class who view the content can be grasped even if a viewer views a broadcast content after the content is stored in a storage device.

The invention disclosed in JP-A 2002-217850 has, however, the following disadvantage. Although the identification information for identifying each of a plurality of contents on a time axis is added to each content, no consideration is given to a status in which a plurality of contents are broadcast simultaneously in one program.

According to the invention disclosed in PCT/JP97/04576 program identification information is acquired by comparing a program viewed and a viewing date of the program with a program table, and the program identification information and a viewer ID are collected while making them correspond to each other.

The invention disclosed in PCT/JP97/04576 is, however, incapable of dealing with a status in which a plurality of contents are broadcast simultaneously in one program.

### SUMMARY OF THE INVENTION

It is an object of the present invention to provide a data broadcast viewing information measuring apparatus, data broadcast viewing information measuring system, and data broadcast viewing information measuring method capable of measuring viewing information on a viewer who views each content even if a plurality of contents are included in one channel.

According to a first aspect of the present invention, there is provided a data broadcast viewing information measuring apparatus comprising: viewing information detection means for detecting at least identification information on a file having a content viewed by a viewer, identification information on a stream to which the file belongs, identification information on a channel to which the stream belongs, and a date at which the content is viewed by the viewer; and transmission means for transmitting at least the identification information on the file, the identification information on the stream, the identification information on the channel, and the date thus detected.

In the data broadcast viewing information measuring apparatus according to the first aspect of the present invention, the viewing information detection means may further detect a program name and a program category, and the transmission means may further transmit the program name and the program category thus detected. The detection means may perform detection regularly.

The data broadcast viewing information measuring apparatus according to the first aspect of the present invention may further comprise: operation detection means for detecting an operation performed by the viewer, the viewing information detection means may perform detection whenever the operation is detected, and the transmission means may further transmit a content of the operation.

According to a second aspect of the present invention, there is provided a data broadcast viewing information measuring system comprising: the data broadcast viewing information measuring apparatus according to the first aspect of the invention; and a rating collecting apparatus, wherein the rating collecting apparatus comprises: reception means for receiving at least the identification information on the file, the identification information on the stream, the identification information on the channel, and the date from the data broadcast information measuring apparatus; and viewing time calculation means for calculating a viewing time of each file based on at least the identification information on the file, the identification information on the stream, the identification information on the channel, and the date received by the reception means.

According to a third aspect of the present invention, there is provided a data broadcast viewing information measuring system comprising: a plurality of the data broadcast viewing information measuring apparatuses stated above; and a rating collecting apparatus, wherein the rating collecting apparatus comprises: reception means for receiving at least the identification information on the file, the identification information on the stream, the identification information on the channel, and the date from the plurality of data broadcast information measuring apparatuses; and rating calculation means for calculating a rating for each attribute of the viewer based on at least the identification information on the file, the identification information on the stream, the identification information on the channel, and the date received by the reception means as well as attribute information on a plurality of viewers.

In the data broadcast viewing information measuring system according to the third aspect of the present invention, the rating calculation means may calculate the rating for an attribute of each viewer and a rating for an attribute of each program based on information on an event information table as well as the file, the identification information on the stream, the identification information on the channel, the date, and the attribute information on the plurality of viewers.

According to a fourth aspect of the present invention, there is provided a data broadcast operativity measuring system comprising: a plurality of the data broadcast information measuring apparatuses stated above; and an operativity measuring apparatus, wherein the operativity measuring apparatus comprises: reception means for receiving at least the identification information on the file, the identification information on the stream, the identification information on the channel, the date, and the content of the operation from the plurality of data broadcast information measuring apparatuses; and operativity measurement means for measuring an operativity of a data broadcast receiver based on the identification information on the file, the identification information on the stream, the identification information on the channel, the date, and the content of the operation received by the reception means.

In the data broadcast operativity measuring system according to the fourth aspect of the present invention, the operativity measuring means may measure the operativity of the data broadcast receiver based on an attribute of the viewer as well as the identification information on the file, the identification information on the stream, the identification information on the channel, the date, and the content of the operation.

According to a fifth aspect of the present invention, there is provided a data broadcast viewing information measuring system comprising: a plurality of the data broadcast viewing information measuring apparatuses stated above; and a rating measuring apparatus, wherein the content of the operation is made to correspond to the content in a data broadcast, and the rating collecting apparatus comprises: reception means for receiving the identification information on the channel, the date, and the content of the operation from the plurality of data broadcast viewing information measuring apparatuses; and rating calculation means for calculating a rating of each content in an aggregation target channel and a rating of each content in an aggregation target time zone based on the identification information on the channel, the date, and the content of the operation received by the reception means.

According to the present invention, identification information on a file having a content viewed by a viewer, identification information on a stream to which the file belongs, and identification information on a channel to which the stream belongs are detected. Therefore, even if a plurality of contents are included in a channel, a rating for each content can be calculated.

According to the present invention, a program name and a program category are detected, from which an interest of each viewer can be grasped.

According to the present invention, the identification information on the file having the content viewed by the viewer, the stream to which the file belongs, and the channel to which the stream belongs are detected regularly and transmitted. Therefore, a rating for each date can be easily calculated.

According to the present invention, the identification information on the file having the content viewed by the viewer, the stream to which the file belongs, and the channel to which the stream belongs are detected whenever the operator's operation is detected and transmitted. Therefore, a viewing time for each content can be accurately obtained.

According to the present invention, the identification information on the file having the content viewed by the viewer, the stream to which the file belongs, and the channel to which the stream belongs are detected, and a rating is calculated based on the detected identification information on the file, the detected identification information on the stream, the detected identification information on the channel, and the date when the content is viewed. Therefore, even if a plurality of contents are included in the channel, a rating for each content can be calculated.

According to the present invention, a rating for each attribute of the viewer is calculated based on the attribute information on a plurality of viewers. Therefore, a program framework, an advertisement method, and the like can be planned in view of the attributes of the viewers.

According to the present invention, the rating for an attribute of each viewer and a rating for an attribute of each program are calculated based on information on an event information table as well as the above-stated information. Therefore, a program framework, an advertisement method, and the like can be planned in view of the attributes of the viewers.

According to the present invention, an operativity of a data broadcast receiver is measured based on the identification information on the file having the content, the identification information on the stream to which the file belongs, the identification information on the channel to which the stream belongs, the date when the content is viewed, and the content of the operation performed by the operator. Therefore, the information can be used to improve a menu configuration of the data broadcast and the like.

According to the present invention, an operativity of a data broadcast receiver is measured based on the identification information on the file having the content, the identification information on the stream to which the file belongs, the identification information on the channel to which the stream belongs, the date when the content is viewed, the content of the operation performed by the operator, and the attribute of the viewer. Therefore, the information can be used to improve a menu configuration of the data broadcast and the like in view of the attributes of viewers.

According to the present invention, the content of the operation is made to correspond to the content in a data broadcast, and a rating of each content in an aggregation target channel and a rating of each content in an aggregation target time zone is calculated based on the identification information on the channel, the date, and the content of the operation. Therefore, the rating can be easily calculated.

### BRIEF DESCRIPTION OF THE DRAWINGS

FIG. 1 is a general view of a terrestrial digital broadcasting system which includes a data broadcast viewing information measuring system according to embodiments of the present invention;

FIG. 2 is a block diagram which depicts configuration of a digital broadcast receiver according to the embodiments of the present invention;

FIG. 3 is a plan view which depicts an external view of a remote controller according to the embodiments of the present invention;

FIG. 4 depicts viewing data acquired in a first embodiment of the present invention;

FIG. 5 depicts viewing data acquired in a second embodiment of the present invention;

FIG. 6 depicts viewing data acquired in a third embodiment of the present invention;

FIG. 7 depicts viewing data acquired in a fourth embodiment of the present invention;

FIG. 8 depicts viewing data acquired in a fifth embodiment of the present invention; and

FIG. 9 depicts viewing data acquired in a sixth embodiment of the present invention.

### DESCRIPTION OF THE PREFERRED EMBODIMENTS

According to the present invention, not only conventional television viewing status information (a viewing start time, a viewed channel, and the like) but also viewing status information on a data content (a name of a BML file in a data broadcast which a view views, identification information on a stream to which the BML file belongs, a button depressed on the BML file displayed, and the like) are recorded and transmitted to a rating collecting apparatus of a rating survey company through the Internet. It is therefore possible to grasp a viewing status of each BML file of a data content and grasp what operation is carried out in the BML file so as to view the BML file.

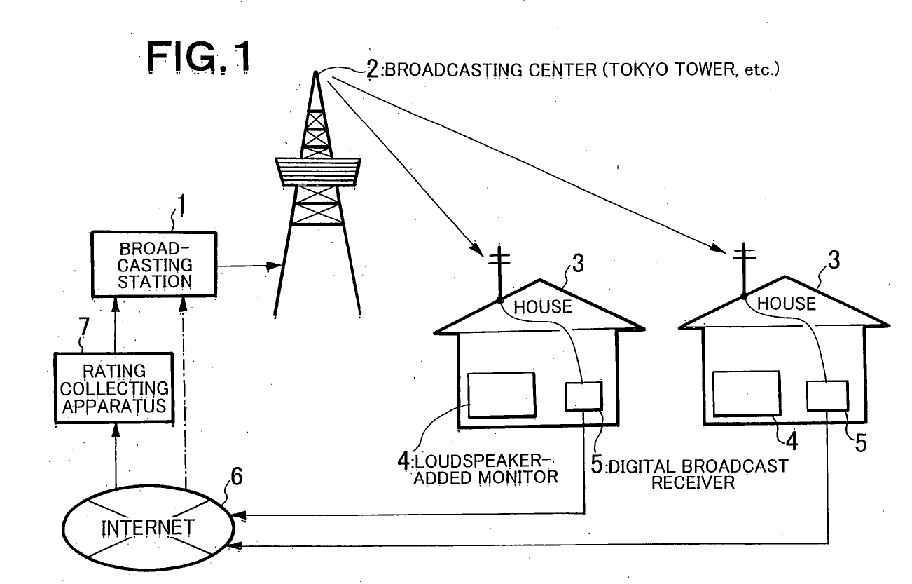

FIG. 1 is a general view of a terrestrial digital broadcasting system which includes a data broadcast viewing information measuring system according to embodiments of the present invention. Referring to FIG. 1, a broadcasting station 1 transmits a digital broadcast to each house through a broadcasting center (e.g., Tokyo Tower) 2. A digital broadcast receiver 5 in each house 3 receives a terrestrial digital broadcast. A loudspeaker-added monitor 4 displays a video and data received by the digital broadcast receiver 5, and produces a voice received by the digital broadcast receiver 5. The digital broadcast receiver 5 includes a data broadcast viewing information measuring apparatus. The data broadcast viewing information measuring apparatus measures and records viewing data (a viewing start time, a viewed channel, a name of a BML file viewed, a component tag of a stream to which the BML file belongs, a button depressed on the BML file displayed, and the like), and transfers the viewing data to a rating collecting apparatus 7 connected to the receiver 5 through the Internet 6.

The rating collecting apparatus 7 aggregates the viewing data, and transmits ratings and a data broadcast viewing status obtained by aggregating the viewing data to the broadcasting station 1. Alternatively, the viewing data may be transferred from the digital broadcast receiver 5 to the broadcasting station 1 through the Internet 6. In this case, the rating collecting apparatus is provided in the broadcasting station 1.

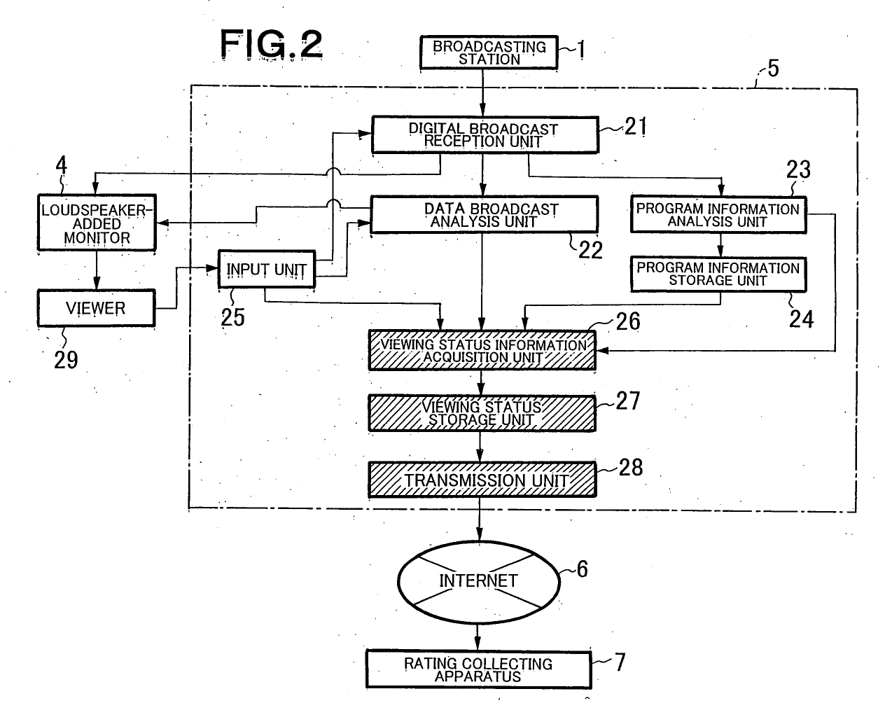

Configuration of the digital broadcast receiver 5 and the like according to preferred embodiments of the present invention will next be described with reference to FIG. 2.

Referring to FIG. 2, the digital broadcast receiver 5 includes a digital broadcast reception unit 21, a data broadcast analysis unit 22, a program information analysis unit 23, a program information storage unit 24, an input unit 25, a viewing status information acquisition unit 26, a viewing status storage unit 27, and a transmission unit 28.

The digital broadcast reception unit 21 receives a radio wave of a digital broadcast transmitted from the broadcasting station 1, demodulates the received radio wave, and outputs a video and a voice in a baseband to the loudspeaker-added monitor 4. The digital broadcast reception unit 21 receives a digital broadcast on a designated channel when the unit 21 receives a channel switchover request from the input unit 25.

The data broadcast analysis unit 22 performs an analysis as to which BML file in a data broadcast included in the digital broadcast received by the digital broadcast reception unit 21 is to be displayed and which BML file in a data broadcast included in the digital broadcast received by the digital broadcast reception unit 21 is not to be displayed according to a key operation which the input unit 25 inputs from a viewer 29. In addition, the data broadcast analysis unit 22 constitutes an image plane according to the BML file to be displayed, and outputs the constituted image plane to the loudspeaker-added monitor 4.

The data broadcast analysis unit 22 performs an operation according to a command in the BML file when receiving a request for a data broadcast related command from the input unit 25. Further, if BML file display is set to be switched over at time intervals, the data broadcast analysis unit 22 conforms to the setting.

The program information analysis unit 23 analyzes an event information table (EIT), which is a kind of service information (SI), received by the digital broadcast reception unit 21, and updates program information (a program start time, a program end time, a program name, a program category, and the like). In addition, if a viewed program is changed to another program, the program information analysis unit 23 notifies the viewing status information acquisition unit 26 of the change of the program.

The program information storage unit 24 stores program information acquired by the program information analysis unit 23.

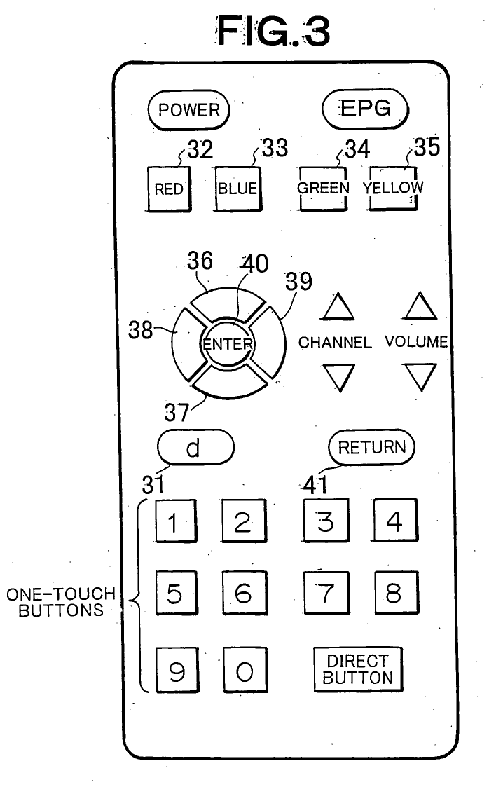

The input unit 25 recognizes and analyzes a command input to a remote controller (see FIG. 3) or the like by the viewer 29 who views the voice and the image output from the loudspeaker-added monitor 4. If the input command is a channel switch command (such as one-touch channel select command, an up-down channel select command, or a direct channel select command), the input unit 25 requests the digital broadcast reception unit 21 to receive a digital broadcast in a channel designated by the viewer 29. If the input command is a data broadcast related command (by depression of a d button 31, a color button (a red button 32, a blue button 33, a green button 34, or a yellow button 35), an up button 36, a down button 37, a left button 38, a right button 39, an enter button 40, a return button 41, or the like (see FIG. 3)), the input unit 25 transmits the input command to the data broadcast analysis unit 22. At the same time, the input unit 25 transmits the channel switchover command, the data broadcast related command, or the like to the viewing status information acquisition unit 26.

If input by the viewer 29 (acquisition from the input unit 25), update of the program (acquisition from the program information analysis unit 23), or update of the displayed BML file (acquisition from the data broadcast analysis unit 22) occurs, then the viewing status information acquisition unit 26 acquires a program name and a category of a program which the viewer 29 views at present from the program storage unit 24, acquires a BML name of the BML file displayed at present and a component tag of the stream to which the BML file belongs from the data broadcast analysis unit 22, and acquires the command input by the viewer 29 from the input unit 25, respectively. Thereafter, the viewing status information acquisition unit 26 transmits the acquired viewing data (the program name, the category name, the BML file name, the component tag value, and the command) as well as data on a present time and a viewed channel to the viewing status storage unit 27 which thereafter stores these pieces of viewing data.

The viewing status storage unit 27 stores the data on the present time, the viewed channel, the program name, the category name, the BML file name, the component tag value, and the command, and notifies the transmission unit 28 of the presence of the stored data.

The transmission unit 28 transmits the viewing data stored in the viewing status storage unit 27 to the rating collecting apparatus 7 through the Internet 6 at a predetermined timing. After transmission, the transmitted viewing data is deleted from the viewing status storage unit 27.

The present invention is applicable not only to the digital broadcast receiver disposed in a house but also a mobile receiver or a portable receiver. If the present invention is applied to the portable receiver, an individual can be specified and viewing status accuracy per personal attribute of the viewer is improved.

After the viewing data has been acquired, the data may be either transmitted at real time or transmitted collectively in a predetermined daily time zone. If the viewing data is transmitted in the predetermined time zone collectively, transmission time may be staggered for respective districts. This can relax concentration of access to the rating collecting apparatus 7.

The application of the present invention is not limited to the terrestrial digital broadcasting. The present invention can be also applied to BS digital broadcasting including data broadcasting and 110-degree CS digital broadcasting. Further, the present invention can be applied to whatever digital broadcasting including data broadcasting.

(First Embodiment)

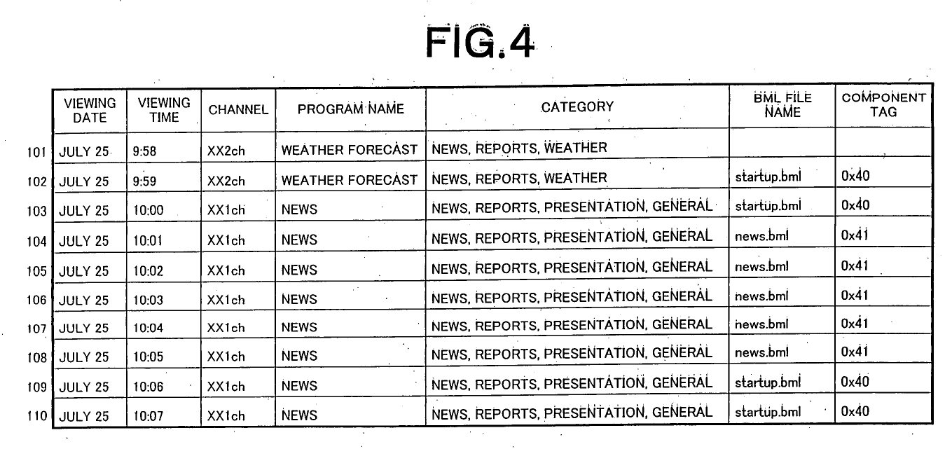

Viewing data acquired in a first embodiment is shown in FIG. 4.

In the first embodiment, the viewing data is recorded every minute. When the viewer 29 turns on the digital television receiver 5 and starts viewing a television program, the digital television receiver 5 acquires the viewing data such as “viewing date”, “viewing time”, “channel”, “program name”, “category”, “BML file name”, and “component tag value”. The “viewing date” is a date when the viewer views the television program. The “viewing time” is a time when the viewer views the television program. The “channel” is a channel which the viewer views at present. The “program name” is the name of the program which the viewer views at present (and which is acquired from the EIT of the data broadcast). The “category” is a category of the program which the viewer views at present (and which is acquired from the EIT of the data broadcast). The “BML file name” is the file name of the displayed BML file in the data broadcast. The “component tag” is a component tag value of a data elementary stream (ES) to which the BML file displayed in the data broadcast belongs.

Specific operations will next be described. It is assumed herein that the viewing data is recorded every minute (at 00 second). However, the viewing data may be recorded every second, every few seconds, or every few tens of seconds.

It is assumed that the viewer 29 turns on the digital broadcast receiver 5 at 9:57 and views “WEATHER FORECAST” in channel XX2. The digital broadcast receiver 5 records the channel, the program name, the category, the BML file name, the component tag related to the program which the viewer views at 9:58 as well as the viewing date and the viewing time. It is assumed that no data broadcast is displayed at this time. If so, the BML file name and the component tag name are blank (101).

It is assumed that the digital broadcast receiver 5 then receives a data broadcast and “startup.bml” in the data ES having a component tag 0×40 is displayed. The digital broadcast receiver 5 records the channel, the program name, the category, the BML file name, the component tag related to the program which the viewer views at 9:59 as well as the viewing date and the viewing time. Since the “startup.bml” in the data ES having the component tag 0×40 is displayed, the digital broadcast receiver 5 records “startup.bml” and “0×40” as the BML file name and the component tag, respectively (102).

It is assumed that, when the channel is switched over to channel XX1, a program named “NEWS” is broadcast. It is also assumed that the digital broadcast receiver 5 receives a data broadcast and displays “startup.bml” in the data ES having the component tag 0×40 . The digital broadcast receiver 5 records the channel, the program name, the BML file name, and the component tag of the program which the viewer views at 10:00 as well as the viewing date and the viewing time (103).

It is assumed that the digital broadcast receiver 5 then operates the digital broadcast and displays “news.bml” in the data ES having the component tag 0×41. The digital broadcast receiver 5 records the viewing data at 10:01 similarly to the above (104).

It is assumed that the digital broadcast receiver 5 displays “news.bml” in the data ES having the component tag 0×41 till 10:05. The digital broadcast receiver 5 records the viewing data at 10:02, 10:03, 10:04 and 10:05 similarly to the above (105 to 108).

It is assumed that the viewer depresses “RETURN” button and the digital broadcast receiver 5 returns to “startup.bml” in the data ES having the component tag 0×40. The digital broadcast receiver 5 records the viewing data at 10:06 similarly to the above (109).

A method for aggregating these pieces of viewing data will next be described. The digital broadcast receiver 5 records the viewing data every minute and then transmits the viewing data to the rating collecting apparatus 7 through the Internet. The rating collecting apparatus 7 can therefore aggregate ratings and viewing statuses of the data broadcast content (BML file name) timely. If no timely viewing information is necessary, the viewing data may be transmitted to the rating collecting apparatus 7 once a day at a fixed time. Alternatively, the viewing data may be transmitted directly to the broadcasting station 1. If so, the broadcasting station 1 can check a viewing trend of the viewer timely and instantaneously reflect the viewing trend in a next program.

(Second Embodiment)

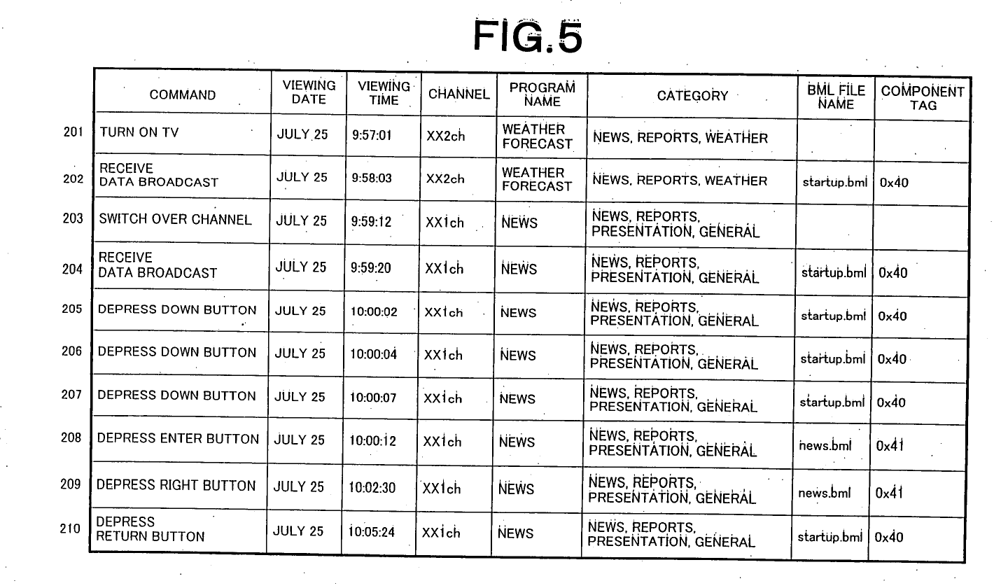

Viewing data acquired in a second embodiment is shown in FIG. 5.

The second embodiment is intended to be able to conduct a survey as to what operation is performed on the data broadcast.

In this embodiment, the digital broadcast receiver 5 records not only the viewing data explained in the first embodiment but also an item “command” as a log. The “command” indicates a content of an operation which the viewer 29 performs on the remote controller. For example, if the viewer 29 turns on the digital broadcast receiver 5, a command “TURN ON TV” is recorded. If the viewer 29 switches over the channel, a command “SWITCH OVER CHANNEL” is recorded. If the digital broadcast receiver 5 receives a data broadcast, a command “RECEIVE DATA BROADCAST” is recorded. If the viewer 29 depresses a data broadcast enter button, a command “DEPRESS ENTER BUTTON” is recorded.

Specific operations will next be described. While the viewing data is detected and recorded every minute in the first embodiment, the viewing data is detected and recorded when command is entered in the second embodiment.

It is assumed that the viewer 29 turns on the digital broadcast receiver 5 at 9:57:01 and views “WEATHER FORECAST” in cannel XX2. In response to the command “TURN ON TV”, the digital broadcast receiver 5 records the command, the channel, the program name, the category, the BML file name, and the component tag as well as the viewing date and the viewing time. At this time, “TURN ON TV” is recorded as the command (201).

It is assumed that the digital broadcast receiver 5 starts receiving a data broadcast at 9:58:03 and displays “startup.bml” in the data ES having the component tag 0×40. In response to the command “RECEIVE DATA BROADCAST”, the digital broadcast receiver 5 records the command, the channel, the program name, the category, the BML file name, and the component tag as well as the viewing date and the viewing time. At this time, “RECEIVE DATA BROADCAST” is recorded as the command (202).

It is assumed that when the channel is switched over to channel XX1, the program “NEWS” is broadcast. In response to the command “SWITCH OVER CHANNEL”, the digital broadcast receiver 5 records the command, the channel, the program name, the category, the BML file, and the component tag as well as the viewing date and the viewing time. At this time, “SWITCH OVER CHANNEL” is recorded as the command (203).

It is assumed that the digital broadcast receiver 5 then receives the data broadcast and displays “startup.bml” in the data ES having the component tag 0×40. In response to the command “RECEIVE DATA BROADCAST”, the digital broadcast receiver 5 similarly records the viewing data (204).

It is assumed that the viewer 29 depresses the down button on the displayed startup.bml at 10:00:02. In response to the command “DEPRESS DOWN BUTTON”, the digital broadcast receiver 5 similarly records the viewing data (205). At this time, “DEPRESS DOWN BUTTON” is recorded as the command (205).

Thereafter, whenever the viewer 29 transmits a command (depresses the down button twice in this embodiment), the digital broadcast receiver 5 similarly records the viewing data (206 and 207).

It is assumed that the viewer 29 depresses the enter button and “news.bml” in the data ES having the component tag 0×41 on the data broadcast screen is displayed. In response to the command “DEPRESS ENTER BUTTON”, the digital broadcast receiver 5 similarly records the viewing data. “DEPRESS ENTER BUTTON” is recorded as the command (208).

It is assumed that the viewer 29 depresses the right and then depresses return button and the “news.bml” in the data ES having the component tag 0×41 is displayed. In response to either command, the digital broadcast receiver 5 similarly records the viewing data (209 and 210).

By thus aggregating the viewing data, it is possible to grasp how long the viewer 29 views what page, by what operation the viewer 29 views data broadcast pages, and the like. Further, it is possible to analyze how many operations the viewer 29 performs and how long it takes until the viewer 29 reaches an intended page. Further, based on the aggregated viewing data, a frequently accessed and popular page can be located in a higher order in a menu so as to facilitate prompt access to the page or can be assigned a color button so as to instantaneously display the page, and the content of a data broadcast in consideration of viewer's operations can be created. If a command interval is long, the viewing data may be recorded not only per command but also regularly (e.g., every minute). If the viewing data is transmitted to the rating collecting apparatus 7 through the Internet whenever the data is recorded, the rating collecting apparatus 7 can timely aggregate ratings and viewing statuses of the data broadcast content (BML file name). Alternatively, the viewing data may be transmitted directly to a content production company which creates the data content. If so, the content production company can promptly take measures to improvement of a usability of the data content or the like.

(Third Embodiment)

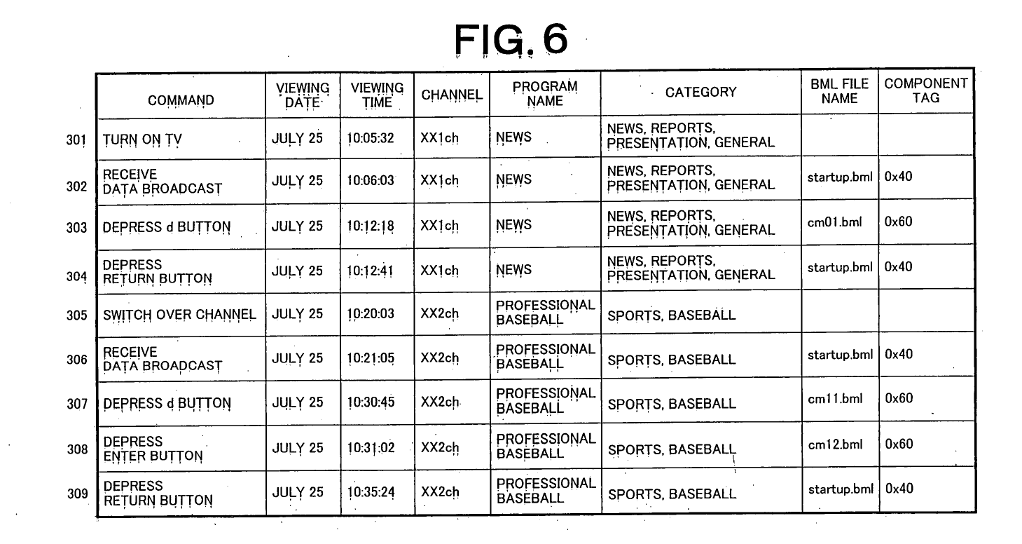

Viewing data acquired in a third embodiment is shown in FIG. 6.

The third embodiment is intended to be able to confirm whether a viewer intentionally views a commercial when the commercial is inserted in a data broadcast.

Items of the viewing data recorded in this embodiment are the same as those in the second embodiment. In addition, the viewing data is recorded per command similarly to the second embodiment. It is assumed herein that a data content which displays a commercial page by depressing the “d button” is present.

Specifically, it is assumed that “startup.bml” displayed first when the operator 29 turns on the digital broadcast receiver 5 or switches over the channel is a transparent page and such a message as “WHEN YOU DEPRESS d BUTTON, SPONSOR's DATA BROADCAST IS DISPLAYED” is displayed by semitransparent characters (“WHEN YOU DEPRESS d BUTTON, SPONSOR's DATA BROADCAST IS DISPLAYED” is displayed on the program image by semitransparent characters).

Specific operations will next be described. The viewing data acquired when the operator 29 performs the following operation is shown in FIG. 6.

It is assumed that the viewer 29 turns on the digital broadcast receiver 5 and views “NEWS” in channel XX1. In response to the command “TURN ON TV”, the digital broadcast receiver 5 records the command, the channel, the program name, and the category as well as the viewing date and the viewing time (301).

It is assumed that the digital broadcast receiver 5 then receives a data broadcast and displays “startup.bml” in the data ES having the component tag 0×40. In response to the command “RECEIVE DATA BROADCAST”, the digital broadcast receiver 5 records the command, the channel, the program name, the category, the BML file name, and the component tag as well as the viewing date and the viewing time (302).

At this time, the semitransparent characters of “WHEN YOU DEPRESS d BUTTON, SPONSOR's DATA BROADCAST IS DISPLAYED” are displayed on the video. The viewer 29 can select whether to view a commercial page according to the viewer's intention. It is assumed herein that the viewer 29 depresses the d button and views the commercial page (“cm01.bml” in the data ES having the component tag 0×60). In response to the command “DEPRESS d BUTTON”, the digital broadcast receiver 5 similarly records the viewing data. “DEPRESS d BUTTON” is recorded as the command (303).

It is assumed that the commercial page does not suite the viewer's interest and the viewer 29 instantaneously depresses the return button. In response to the command “DEPRESS RETURN BUTTON”, the digital broadcast receiver 5 records the viewing data. “DEPRESS RETURN BUTTON” is recorded as the command (304).

Since a time from “DEPRESS d BUTTON” to “DEPRESS RETURN BUTTON” is short, it can be analyzed that the viewer 29 does not view the commercial page for a long time and the commercial does not suit the viewer's interest.

Next, it is assumed that the viewer 29 switches over the channel to channel XX2 and views “PROFESSIONAL BASEBALL”. In response to the demand “SWITCH OVER CHANNEL”, the digital broadcast receiver 5 similarly records the viewing data (305).

It is assumed that the digital broadcast receiver 5 then receives a data broadcast. In response to the command “RECEIVE DATA BROADCAST”, the digital broadcast receiver 5 similarly records the viewing data (306).

At this time, similarly to the channel XX1, the semitransparent characters of “WHEN YOU DEPRESS d BUTTON, SPONSOR's DATA BROADCAST IS DISPLAYED” are displayed on the “startup.bml” displayed at present.

Similarly to the above, it is assumed herein that the viewer 29 depresses the d button and views the commercial page (“cm01.bml” in the data ES having the component tag 0×60). In response to the command “DEPRESS d BUTTON”, the digital broadcast receiver 5 similarly records the viewing data (307).

It is assumed that, since this commercial page suites viewer's taste, the viewer 29 depresses the enter button to view the next page of the commercial (“cm12.bml” in the data ES having a component tag 0×60). In response to the command “DEPRESS ENTER BUTTON”, the digital broadcast receiver 5 similarly records the viewing data (308).

It is assumed that the viewer 29 views the commercial page for about four minutes and depresses the return button. In response to the command “DEPRESS RETURN BUTTON”, the digital broadcast receiver 5 similarly records the viewing data (309).

Since the time from the “DEPRESS d BUTTON” to “DEPRESS RETURN BUTTON” is long and the viewer 29 views up to the next page of the commercial, it can be analyzed that the commercial suites the viewer's interest. By analyzing these pieces of viewing data, it can be determined whether the viewer 29 has intentionally viewed the commercial and how long the viewer 29 has viewed the commercial. Based on a result of this analysis, the sponsor can grasp a time zone in which the commercial of the sponsor can be viewed and a program into which the commercial is inserted so that the commercial can be viewed. Therefore, it is possible to elaborate an effective advertisement strategy. Alternatively, the viewing data may be directly transmitted to the sponsor. If so, the sponsor can timely check a viewing trend of the commercial and promptly determine whether to insert the commercial in the same program next time.

In the third embodiment, the channel, the BML file name, the component tag, and the like are measured per command. By doing so, whether the time from one command to the next command is long or short, the time can be accurately measured. However, even if the channel, the BML file name, the component tag, and the like are recorded regularly as explained in the first embodiment, the time from one command to the next command can be accurately measured irrespective of whether the time is long or short as long as a measurement interval is short.

(Fourth Embodiment)

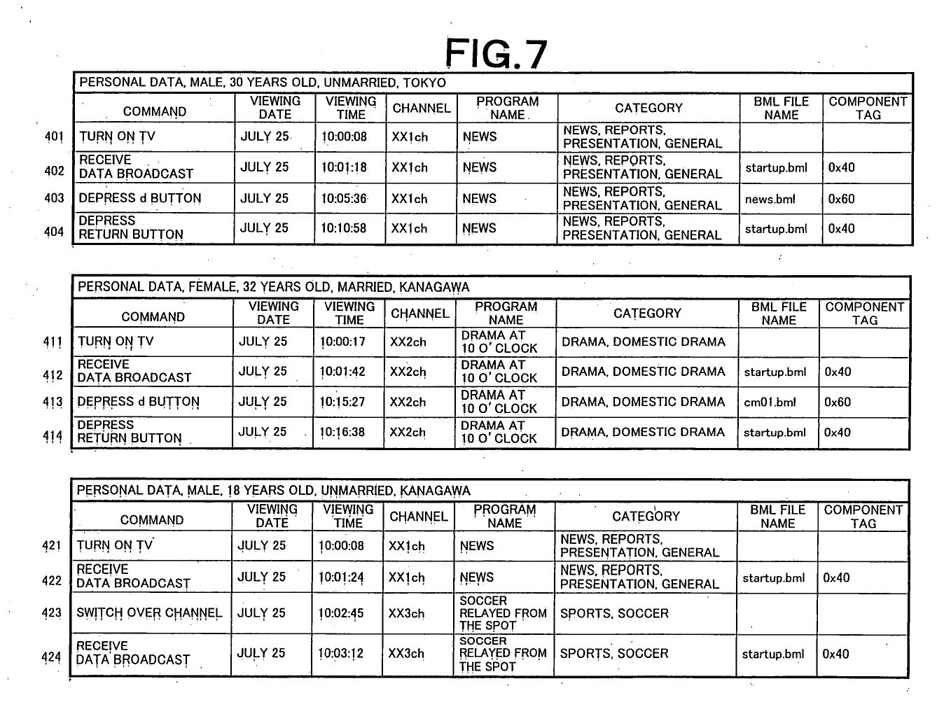

Viewing data acquired in a fourth embodiment is shown in FIG. 7.

The fourth embodiment is intended to be able to conduct a survey as to what program draws interest according to sex, age, and districts, and as to what data broadcast draws interest according to sex, age, and district.

To classify personal types of viewers, viewer attribute information such as sex, age, and married/unmarried is added to the viewing data as shown in FIG. 7. In the example of FIG. 7, viewing data on a person with attributes of male/30 years old/unmarried/Tokyo, a person with attributes of female/32 years old/married/Kanagawa, and a person with attributes of male/18 years old/unmarried/Kanagawa is recorded as viewer attribute information. The viewer attribute information may be recorded in a rating survey apparatus disposed in each house. Alternatively, the viewer attribute information may be recorded in a database of the rating collecting apparatus 7 in advance and then combined with the viewing data later in the rating collecting apparatus 7. In the latter case, a rating measuring apparatus inputs and holds viewer identification information on each viewer in advance. When transmitting the viewing data to the rating collecting apparatus, the rating measuring apparatus also transmits the viewer identification information to the rating collecting apparatus 7. The rating collecting apparatus 7 records the viewer attribute information and the viewer identification information in the database while making them correspond to each other so that the viewing data and the viewer attribute information on each viewer can be combined by the viewer identification information.

As shown in FIG. 7, the person with attributes of male/30 years old/unmarried/Tokyo turns on the digital broadcast television 5 and views “NEWS” in channel XX1 at 10:00:08, depresses the d button and views the page of “news.bml” at 10:05:36, and then depresses the return button and returns to the news program at 10:10:58 (401 to 404).

Further, the person with attributes of female/32 years old/married/Kanagawa turns on the digital broadcast television 5 and views “DRAMA” in channel XX2 at 10:00:17, depresses the d button and views the page of “cm01.bml” at 10:15:27, and then depresses the return button and returns to the drama program at 10:16:38 (411 to 4104).

The person with attributes of male/18 years old/unmarried/Kanagawa turns on the digital broadcast television 5 at 10:00:08, and promptly switches over to channel XX3 to view “SOCCER RELAYED FROM THE SPOT” (421 to 424).

By thus allowing the rating collecting apparatus to aggregate these pieces of viewing data according to sex, age, married/unmarried, and district, it is possible to acquire viewing data according to sex, age, married/unmarried, and district. Namely, it is possible to acquire information, e.g., this age class views programs in this time zone or this program, married persons do not view television in this time zone, males frequently view these pages of the data broadcast, or females tend to frequently view programs in this category, by analyzing the viewing data. As a result, an advertisement effect of a product having target viewers can be heightened by inserting a commercial of the product in programs which the target viewers frequently view or in programs in time zones in which the target viewers frequently view. Further, the viewing data can be instantaneously collected and analyzed through the Internet. Therefore, if it is determined that the advertisement effect is stronger in a program broadcast today than in another program, the latter program into which the commercial is inserted can be replaced by the former program.

Furthermore, a performers' item may be added to the items of the viewing data. Information on performers can be acquired from the EIT. By adding the performers' item to the viewing data, it is possible to determine persons in which age class are interested in performers in which type by analyzing the viewing data.

In addition, the rating collecting apparatus 7 can aggregate ratings of a data broadcast content with a specific title or in a specific type in a specific category for each viewer attribute information.

(Fifth Embodiment)

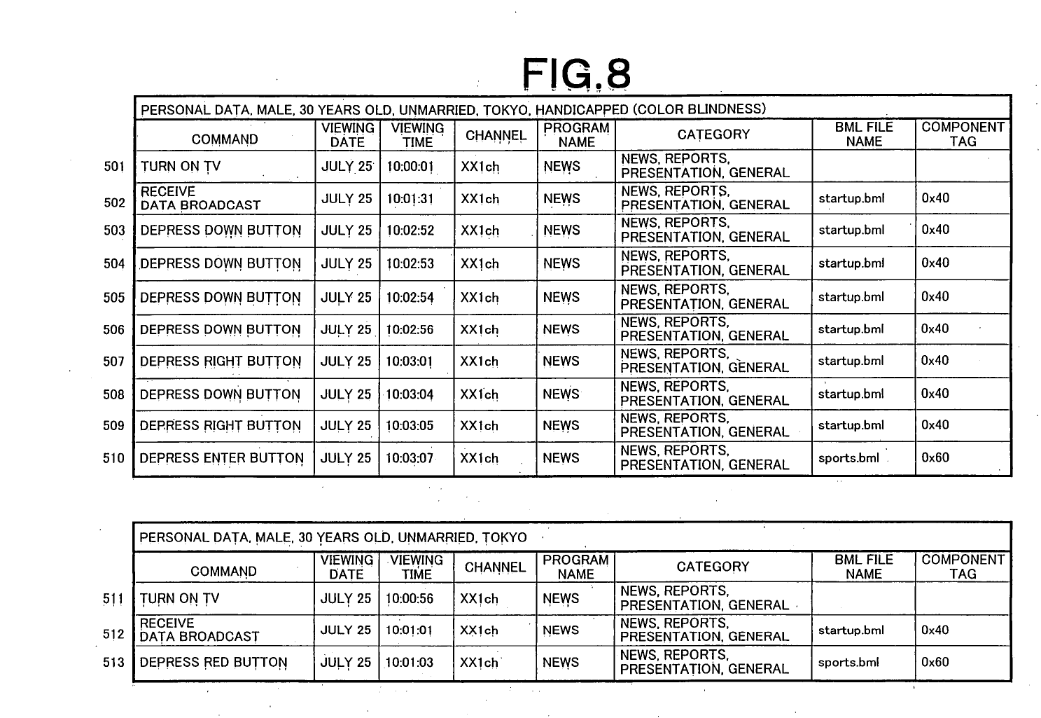

Viewing data acquired in a fifth embodiment is shown in FIG. 8.

The fifth embodiment is intended to be able to conduct survey as to how a mentally or physically handicapped person uses a data broadcast content.

As shown in FIG. 8, information on a state of a handicapped person is added as personal data so that it is possible to grasp a handicap of the person. In this embodiment, an example of a viewer with color blindness (hereinafter, “color-blind viewer”) will be described. In addition, viewing data in a case where the operation for obtaining the same result is carried out by a viewer who is not a handicapped person will be described. It is noted that the viewing data is recorded per command.

Operations performed by the color-blind viewer can be read from the viewing data shown in FIG. 5. The operation will be described specifically.

The color-blind viewer turns on the digital broadcast receiver 5 at 10:00:01, receives a data broadcast, and then depresses the down button and right button to display an intended sports page (“sports.bml” in the data ES having a component tag 0×60) (501 to 510).

It is assumed that the “sports.bml” is assigned to a red button. Since the color-blind viewer does not know that the “sports.bml” is assigned to the red button, the color-blind viewer reaches the target sports page by performing the above-stated operation.

If the viewer is not color blind, the viewer turns on the digital broadcast receiver 5 at 10:00:56, receives a data broadcast, and then depresses the red button. The intended sports page can be displayed (511 to 513).

It can be determined from the viewing data that the content of this data broadcast gives no consideration to color-blind viewers. This result can be used as a determination material as to how a content friendly to color-blind viewers can be created.

It is noted that whether the viewer is handicapped or not is a kind of the viewer attribute information in the fourth embodiment, and the information can be dealt with similarly to the fourth embodiment.

(Sixth Embodiment)

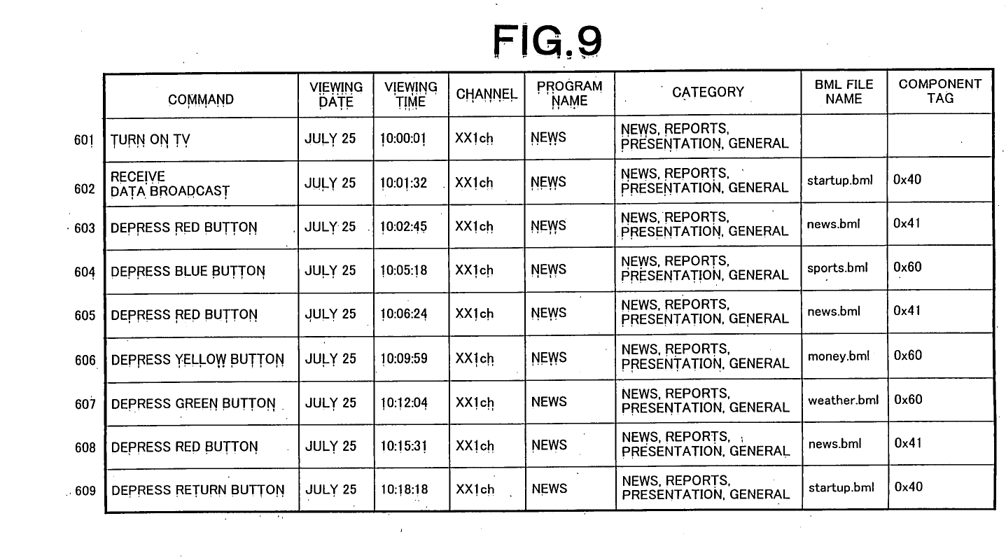

Viewing data acquired in a sixth embodiment is shown in FIG. 9.

The sixth embodiment is intended to aggregate the viewing data by assigning a specific page to each color button within a content of a data broadcast on at least a predetermined channel in a predetermined time zone.

It is assumed that a specific type of content is assigned to each color button within the content of the data broadcast. For example, a page of “LATEST NEWS” is assigned to a red button, a page of “SPORT INFORMATION” is assigned to a blue button, a page of “WEATHER FORECAST” is assigned to a green button, and a page of “MONEY INFORMATION” is assigned to a yellow button. In this case, it is assumed that an operation of depressing each color button is the same among all pages. Namely, on the page of “startup.bml”, the red, blue, green, and yellow buttons are displayed. On the page of “LATEST NEWS”, the blue, green, and yellow buttons are displayed. On the page of “SPORTS INFORMATION”, the red, green, and yellow buttons are displayed. On the page of “WEATHER FORECAST”, the red, blue, and yellow buttons are displayed. On the page of “MONEY INFORMATION”, the red, blue, and green buttons are displayed. On whichever page the viewer depresses the red button, the page of “LATEST NEWS” is displayed. On whichever page the viewer depresses the blue button, the page of “SPORTS INFORMATION” is displayed. On whichever page the viewer depresses the green button, the page of “WEATHER FORECAST” is displayed. On whichever page the viewer depresses the yellow button, the page of “MONEY INFORMATION” is displayed.

In this embodiment, attention is paid to color button commands (“DEPRESS RED BUTTON”, “DEPRESS BLUE BUTTON”, “DEPRESS GREEN BUTTON”, and “DEPRESS YELLOW BUTTON”). It is noted that the viewing data is recorded per command.

Specific operations will be described.

First, when the viewer turns on the digital broadcast receiver 5, the digital broadcast receiver 5 records the viewing data (601). When the digital broadcast receiver 5 receives a data broadcast, the digital broadcast receiver 5 similarly records the viewing data (602). Thereafter, whenever the viewer depresses one color button (the red button, the blue button, the green button, or the yellow button), the digital broadcast receiver 5 similarly records the viewing data (603 to 608). In this embodiment, the viewer depresses the red button three times, the blue button once, the green button once, and the yellow button once. That is, it can be analyzed that the page of “LATEST NEWS” is depressed three times, the page of “SPORTS INFORMATION” is depressed once, the page of “WEATHER INFORMATION” is depressed once, and the page of “MONEY INFORMATION” is depressed once. As can be seen, if the numbers of times of depression of the red, blue, green, and yellow buttons are counted from the viewing data commands, it is possible to grasp which page is viewed how often and, therefore, facilitate aggregation. It is also possible to grasp how long which page is viewed based on the viewing time.

In the terrestrial digital television broadcasting, a link of the data broadcast is not limited to the BML file but the data broadcast often links to a website (HTML file) through the Internet.

In each of the embodiments stated above, the link of the data broadcast is not limited to the BML file and the data broadcast often links to a website. Even so, it is possible to grasp how often the viewer accesses which page in what way by checking URLs.

Further, if it is assumed in advance that a website of a broadcasting station is displayed with the red button, and a website of a sponsor is displayed with the blue button, then the number of times of access to each website can be grasped from the number of times of depression of each color button based on the content of the data broadcast.

The present invention can be used for measurement of ratings for the data broadcast.

1. A data broadcast viewing information measuring apparatus comprising:
viewing information detection means for detecting at least identification information on a file having a content viewed by a viewer, identification information on a stream to which the file belongs, identification information on a channel to which the stream belongs, and a date at which the content is viewed by the viewer; and
transmission means for transmitting at least the identification information on the file, the identification information on the stream, the identification information on the channel, and the date thus detected.

2. The data broadcast viewing information measuring apparatus according to claim 1, wherein
the viewing information detection means further detects a program name and a program category, and
the transmission means further transmits the program name and the program category thus detected.

3. The data broadcast viewing information measuring apparatus according to claim 1, wherein
the detection means performs detection regularly.

4. The data broadcast viewing information measuring apparatus according to claim 1, further comprising:
operation detection means for detecting an operation performed by the viewer, wherein
the viewing information detection means performs detection whenever the operation is detected, and
the transmission means further transmits a content of the operation.

5. A data broadcast viewing information measuring system comprising:
the data broadcast viewing information measuring apparatus according to claim 1; and
a rating collecting apparatus, wherein
the rating collecting apparatus comprises:
reception means for receiving at least the identification information on the file, the identification information on the stream, the identification information on the channel, and the date from the data broadcast information measuring apparatus; and
viewing time calculation means for calculating a viewing time of each file based on at least the identification information on the file, the identification information on the stream, the identification information on the channel, and the date received by the reception means.

6. A data broadcast viewing information measuring system comprising:
a plurality of the data broadcast viewing information measuring apparatuses according to claim 1; and
a rating collecting apparatus, wherein
the rating collecting apparatus comprises:
reception means for receiving at least the identification information on the file, the identification information on the stream, the identification information on the channel, and the date from the plurality of data broadcast information measuring apparatuses; and
rating calculation means for calculating a rating for each attribute of the viewer based on at least the identification information on the file, the identification information on the stream, the identification information on the channel, and the date received by the reception means as well as attribute information on a plurality of viewers.

7. The data broadcast viewing information measuring system according to claim 6, wherein
the rating calculation means calculates the rating for an attribute of each viewer and a rating for an attribute of each program based on information on an event information table as well as the file, the identification information on the stream, the identification information on the channel, the date, and the attribute information on the plurality of viewers.

8. A data broadcast operativity measuring system comprising:
a plurality of the data broadcast information measuring apparatuses according to claim 4; and
an operativity measuring apparatus, wherein
the operativity measuring apparatus comprises:
reception means for receiving at least the identification information on the file, the identification information on the stream, the identification information on the channel, the date, and the content of the operation from the plurality of data broadcast information measuring apparatuses; and
operativity measurement means for measuring an operativity of a data broadcast receiver based on the identification information on the file, the identification information on the stream, the identification information on the channel, the date, and the content of the operation received by the reception means.

9. The data broadcast operativity measuring system according to claim 8, wherein
the operativity measuring means measures the operativity of the data broadcast receiver based on an attribute of the viewer as well as the identification information on the file, the identification information on the stream, the identification information on the channel, the date, and the content of the operation.

10. A data broadcast viewing information measuring system comprising:
a plurality of the data broadcast viewing information measuring apparatuses according to claim 4; and
a rating mesuring apparatus, wherein
the content of the operation is made to correspond to the content in a data broadcast, and
the rating collecting apparatus comprises:
reception means for receiving the identification information on the channel, the date, and the content of the operation from the plurality of data broadcast viewing information measuring apparatuses; and
rating calculation means for calculating a rating of each content in an aggregation target channel and a rating of each content in an aggregation target time zone based on the identification information on the channel, the date, and the content of the operation received by the reception means.

11. A data broadcast viewing information measuring method comprising:
a viewing information detection step of detecting at least identification information on a file having a content viewed by a viewer, identification information on a stream to which the file belongs, identification information on a channel to which the stream belongs, and a date at which the content is viewed by the viewer; and
a transmission step of transmitting at least the identification information on the file, the identification information on the stream, the identification information on the channel, and the date thus detected.

12. The data broadcast viewing information measuring method according to claim 11, wherein
at the viewing information detection step, a program name and a program category are further detected, and
at the transmission step, the program name and the program category thus detected are further transmitted.

13. The data broadcast viewing information measuring method according to claim 11, wherein
at the detection step, detection is performed regularly.

14. The data broadcast viewing information measuring method according to claim 11, further comprising:
an operation detection step of detecting an operation performed by the viewer, wherein
at the viewing information detection step, detection is performed whenever the operation is detected, and
at the transmission step, a content of the operation is further transmitted.

15. The data broadcast viewing information measuring method according to claim 11, further comprising:
a viewing time calculation step of calculating a viewing time of each file based on at least the identification information on the file, the identification information on the stream, the identification information on the channel, and the date.

16. The data broadcast viewing information measuring method according to claim 11, further comprising:
a rating calculation step of calculating a rating for each attribute of the viewer based on at least the identification information on the file, the identification information on the stream, the identification information on the channel, and the date as well as attribute information on a plurality of viewers for the plurality of viewers.

17. The data broadcast viewing information measuring method according to claim 16, wherein
at the rating calculation step, the rating for an attribute of each viewer and a rating for an attribute of each program are calculated based on information on an event information table as well as the file, the identification information on the stream, the identification information on the channel, the date, and the attribute information on the plurality of viewers.

18. A data broadcast operativity measuring method according in the data broadcast information measuring method according to claim 14, further comprising:
an operativity measurement step of measuring an operativity of a data broadcast receiver based on the identification information on the file, the identification information on the stream, the identification information on the channel, the date, and the content of the operation for a plurality of viewers.

19. The data broadcast operativity measuring method according to claim 18, wherein
at the operativity measurement step, the operativity of the data broadcast receiver is measures based on an attribute of the viewer as well as the identification information on the file, the identification information on the stream, the identification information on the channel, the date, and the content of the operation.

20. A data broadcast viewing information measuring method according to claim 14, further comprising:
a rating calculation step of calculating a rating of each content in an aggregation target channel and a rating of each content in an aggregation target time zone based on the identification information on the channel, the date, and the content of the operation for a plurality of viewers.
